(19) United States
(12) Patent Application Publication
(10) Pub. No.: US 2015/0081428 A1
(43) Pub. Date: Mar. 19, 2015

(54) SYSTEM AND METHOD FOR PRODUCT-CATEGORIZED MARKETING AND SHOPPING

(71) Applicant: KIDS II, INC., Atlanta, GA (US)

(72) Inventors: Daniel MARE, Marietta, GA (US); Meredith Marsh LATHAM, Atlanta, GA (US); Alyson EDSON, Atlanta, GA (US)

(73) Assignee: KIDS II, INC., Atlanta, GA (US)

(21) Appl. No.: 14/482,833

(22) Filed: Sep. 10, 2014

Related U.S. Application Data
(60) Provisional application No. 61/879,337, filed on Sep. 18, 2013.

(51) Int. Cl. G06Q 30/02

(52) U.S. Cl. CPC G06Q 30/0251
USPC 705/14.49

(57) ABSTRACT

A system and method for improved efficiency in the marketing and purchase of products within a marketplace. At least one category of information associated with a group of products is defined, and at least one product-specific categorization is identified within each category of information. At least one product-specific categorization is associated with a particular product selected from the group of products, and the product-specific categorization associated with the particular product is communicated to a potential customer to assist in a purchasing decision.

### CROSS-REFERENCE TO RELATED APPLICATIONS

This application claims the benefit of U.S. Provisional Patent Application Ser. No. 61/879,337 filed Sep. 18, 2013, the entirety of which is hereby incorporated herein by reference for all purposes.

### TECHNICAL FIELD

The present invention relates generally to the field of marketing and sales of products, and more particularly to a system and method for improved efficiency in product marketing and product selection by shoppers.

### BACKGROUND

Various methods are used to convey marketing and product information to shoppers, such as in store point-of-purchase/point-of-sale displays, product brochures, displays on websites for online store purchasing, signage, promotional materials, product packaging, electronic advertising media, and the like. The number of products available in both physical and online stores, and the volume of product information available to consumers in the modern marketplace can make the shopping and purchasing experience overwhelming at times. Often the specific information a customer is seeking in order to make a purchasing decision is difficult to find amongst all of the material available.

Known systems and methods of marketing and shopping for products can also be inefficient due to the lack of an effective manner of categorizing and communicating product information in a way that allows customers to easily compare one product to another, or to identify the intended usage of a product or product characteristics within various types of products available for consideration. Infants and children's products, for example, present a particular challenge in categorizing and communicating product information due to factors such as parent or child's preferences, physical growth and changing of sizes, and the large number of products available for various stages of a child's development. As a particular example, swaddles for wrapping an infant are available in multiple formats, types and sizes, from traditional wrap-up blanket type swaddles, to zip-up swaddles, to transitional or convertible swaddle/sleepwear garments; as well as variations in snugness or roominess of fit, warmth or ventilated swaddles, and different sizes corresponding to the infant's height and/or weight.

Accordingly, it can be seen that needs exist for improved systems and methods of marketing and selection of products, such as for example infants and children's products such as swaddles. It is to the provision of improved systems and methods of marketing and selection of products meeting these and other needs that the present invention is primarily directed.

### SUMMARY

The present invention provides improved systems and methods of marketing and selection of products, such as for example infants and children's products such as swaddles. Example systems and methods falling within the scope of the present invention provide efficient categorization and communication of product information, allowing manufacturers and retailers to more effectively market products, and allowing customers to more effectively identify product characteristics and uses and more easily make informed purchasing decisions.

While adaptable for use in connection with various products and/or services, example embodiments of the invention relate to a shopping system and method for infant and children's products such as infant swaddling devices. In example forms, the shopping system and method defines and comprises one or more categories containing one or more options from which a user can select to help identify their ideal swaddling device. Example categories that the swaddling system can be based on include, but are not limited to, size, function, and style.

In one aspect, the present invention relates to a method for improved efficiency in the marketing and purchase of products within a marketplace. The method preferably includes the steps of defining at least one category of information associated with a group of products; identifying at least one product-specific categorization within each category of information; associating at least one product-specific categorization with a particular product selected from the group of products; and communicating the product-specific categorization associated with the particular product to a potential customer.

In another aspect, the invention relates to a system for improved efficiency in the marketing and purchase of products within a marketplace. The system preferably includes a group of products, each particular product within the group of products comprising at least one product-specific categorization characteristic corresponding to an associated category of information relevant to the group of products. The system preferably also includes at least one product-specific categorization display indicia associated with each particular product.

In another aspect, the invention relates to a product selected from a group of products, the group of products collectively having a plurality of associated characteristics within at least one category. The product selected from the group of products comprises at least one of the plurality of associated characteristics in each category, and further comprises at least one product-specific categorization display indicia associated with the product selected from the group of products.

In another aspect, the invention relates to a product-specific categorization display indicia for use in association with a product selected from a group of products, the group of products collectively having a plurality of associated characteristics within at least one category. The product selected from the group of products comprises at least one of the plurality of associated characteristics in each category. The product-specific categorization display indicia corresponds to the at least one of the plurality of associated characteristics of the product selected from the group of products.

These and other aspects, features and advantages of the invention will be understood with reference to the drawing figures and detailed description herein, and will be realized by means of the various elements and combinations particularly pointed out in the appended claims. It is to be understood that both the foregoing general description and the following brief description of the drawings and detailed description of the invention are exemplary and explanatory of preferred embodiments of the invention, and are not restrictive of the invention, as claimed.

### BRIEF DESCRIPTION OF THE DRAWINGS

FIG. 1 shows a display for use in connection with a shopping and marketing system and method according to an example embodiment of the present invention.

FIG. 2 shows categorization by style/platform type according to the system and method of the display shown in FIG. 1.

FIG. 3 shows categorization by function/benefits according to the system and method of the display shown in FIG. 1.

FIG. 4 shows categorization by size according to the system and method of the display shown in FIG. 1.

FIG. 5 shows another display for use in connection with a shopping and marketing system and method according to another example embodiment of the present invention.

FIGS. 6A and 6B show packaging and labeling (back and front faces) of a product, according to an example embodiment of the invention.

### DETAILED DESCRIPTION OF EXAMPLE EMBODIMENTS

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Any and all patents and other publications identified in this specification are incorporated by reference as though fully set forth herein.

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

The present invention is generally directed to the field of shopping and marketing systems and methods, for example to a shopping system or method for infant and children's products such as infant swaddling devices. The shopping system and method defines and comprises one or more categories containing one or more options from which a user can select to help identify their ideal swaddling device, or other products or services to which an embodiment of the system and method of the invention are applied. The shopping system and method further comprises one or more modalities for display and/or communication of the categories and options applicable to a particular product. Example categories that the swaddling system can be based on include, but are not limited to, size, function, and style. Example embodiments of categories and options for such a shopping system are shown in Table 1 below:

TABLE 1

| STYLE/PLATFORM | | |
|---|---|---|
| TYPE | FUNCTION/BENEFITS | SIZE |
| Original | Hug baby | Preemie \| 0-3 \| S |
| Square Blankets | Warm baby | Newborn \| 6-12 \| M |
| Footsies | Soothe baby | Infant \| 6-12 \| L |
| Air/Convertible | Comfort baby | Whoa Baby \| 12-18 \| |
| | | XL |
| Sleep Sack | (Ease of use/ | |
| | understanding) | |
| Multi Pack | | |

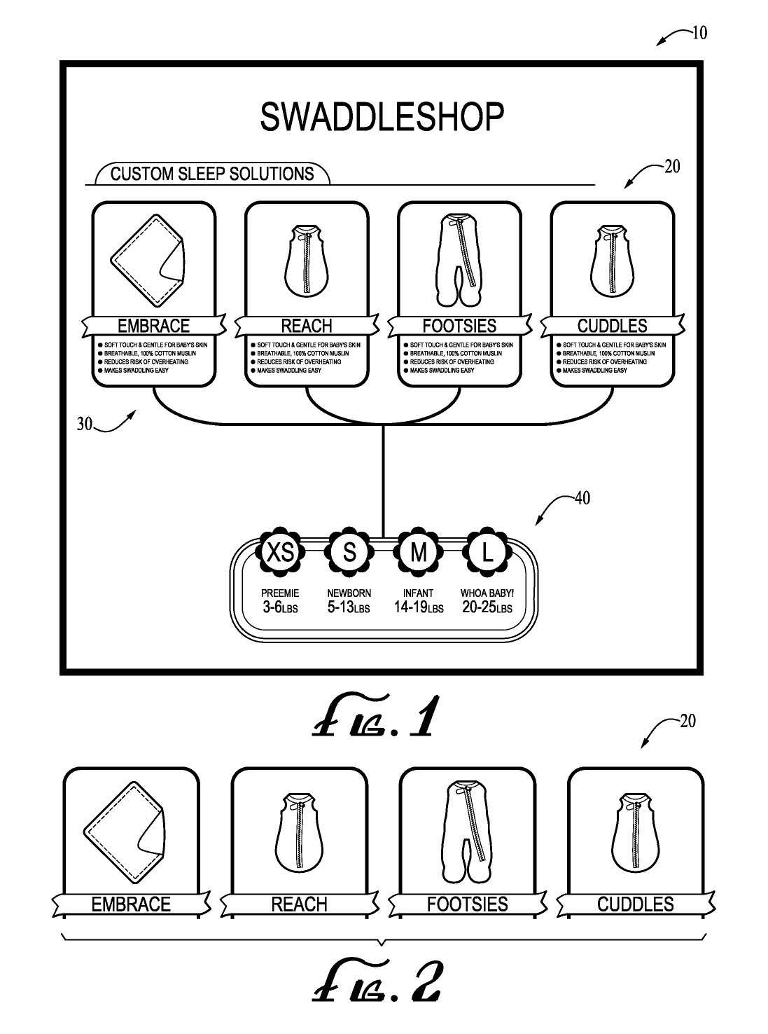

The shopping system can utilize one or more color(s), icon(s), text, Image(s), photography, and/or other visual indicators to indicate categorization and options within a category applicable to a product to help consumers shop for different swaddle solutions. FIG. 1 shows an example explanatory display 10 associated with swaddle products to which the system and method of the invention are applicable. Such explanatory displays can be used on packaging and at store level, either in physical stores or online stores, such as on multi-media displays, print ads, packaging, labeling, POPs (point of purchase displays), product brochures, media advertising, signage, promotional materials, product packaging, packaging inserts, store level signage/marketing, online or digital marketing content, and various other display/communication media.

The manufacturer, retailer, marketing consultant or other party defines one or more product categories 20, 30, 40 under which products or services are to be identified, for example by selection from those identified herein and/or other categories relevant to a particular market or type of product or service. Within each category so defined, one or more options or characteristics for products or services (product-specific categorizations) are identified, optionally defining a product characteristic matrix as shown in FIG. 1. One or more particular products or services, and preferably a plurality of products or services representing a variety of different product types within a market segment are identified and categorized according to selected categories and options from the defined list or matrix. Indicia corresponding to the identified options or product characteristics of the one or more particular products is then associated with each particular product and displayed or communicated to potential customers. Various means of displaying or communicating the product-specific categorizations may be utilized in association with the products on product-specific categorization display indicia, including without limitation, multi-media displays, print ads, packaging, labeling, POPs (point of purchase displays), product brochures, media advertising, signage, promotional materials, product packaging, packaging inserts, store level signage/marketing, online or digital marketing content, and various other display/communication media.

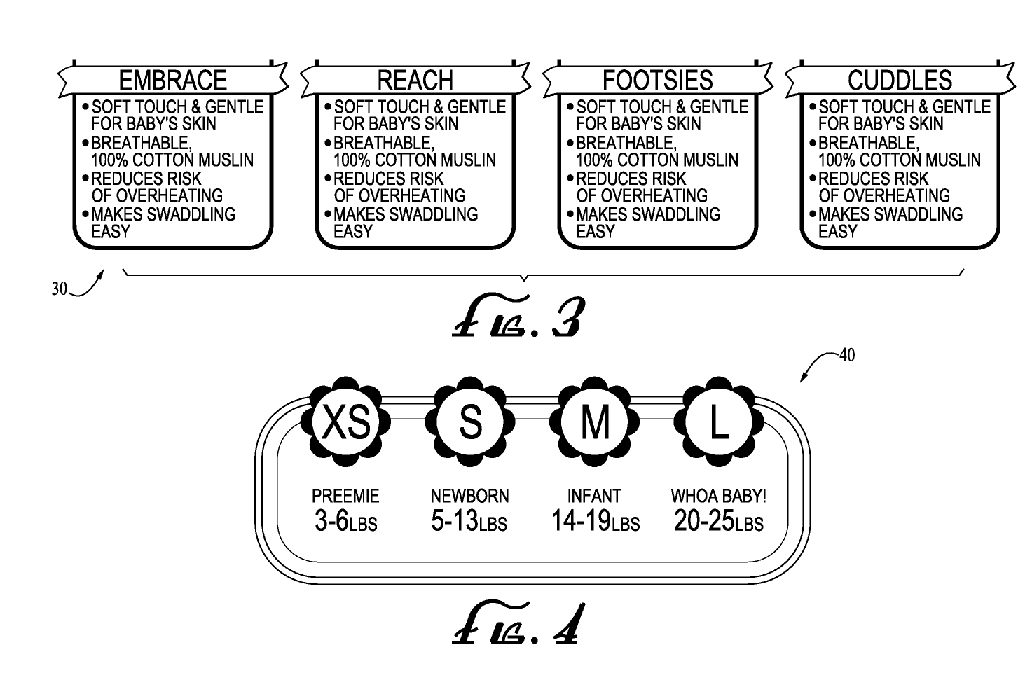

With reference to FIG. 2, example embodiments of the shopping and marketing system method of the present invention can include Style/Platform Type indicia 20 and/or text that represents and differentiates between different types of swaddle devices. For example, a peanut shape or a square blanket, legs or no legs, etc. According to example embodiments, an icon or photography thumbnail can be utilized to visually communicate the different styles/platform types to a consumer. Each style/platform can also be named and/or color coded. Thus, as illustrated in the example embodiment shown above, each different style/platform can be identified by a icon/photo, a name, and a color. The selected indicia are preferably standardized across a product category or market segment, such that potential purchasers can become familiar with the system and method, either by reference to an explanatory display or intuitively or experientially by exposure to and use of the product-specific categorization display indicia on particular products considered for purchase.

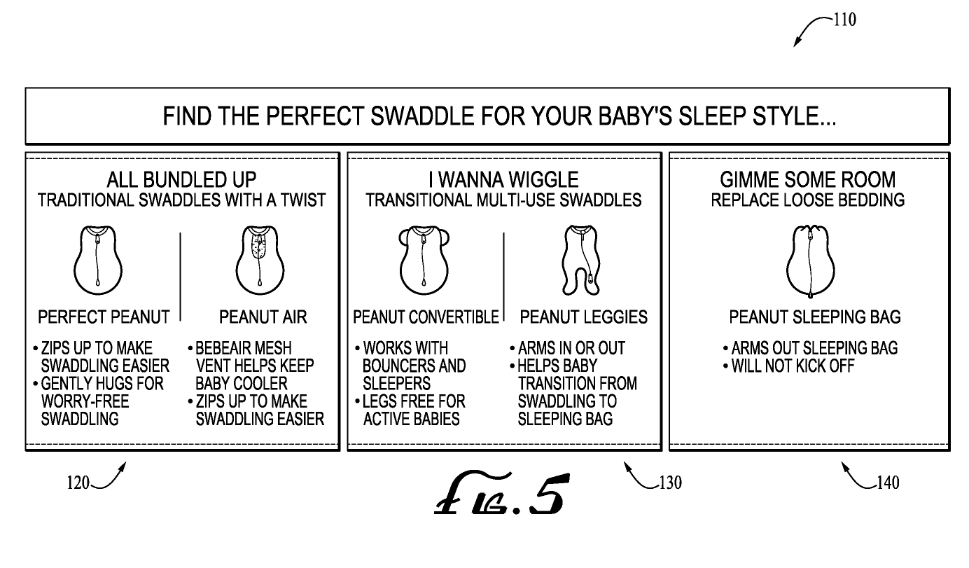

With reference to FIG. 3, example embodiments of the shopping and marketing system method of the present invention can further include Function/Benefit indicia 30 and/or text that illustrates and/or describes the functions and benefits of the associated style/platform. The function/benefit category serves as an educational tool, informing consumers about various issues presented by typical swaddling devices and the solution that is provided by that specific style/platform, helping the consumer to select the ideal swaddling device for their baby. (Example of problem/solution based marketing.)

With reference to FIG. 4, example embodiments of the shopping and marketing system method of the present invention can further include a sizing grid 40. According to example embodiments, the sizing grid can be based on age (preemie, newborn, infant, whoa baby), weight, length, and/or basic measuring units (S, M, L, XL). This provides the customer the ability to identify a suitable size using multiple factors, better ensuring that the most appropriate size is selected. The sizing grid can utilize color, images, text or other visual indicators to communicate size.

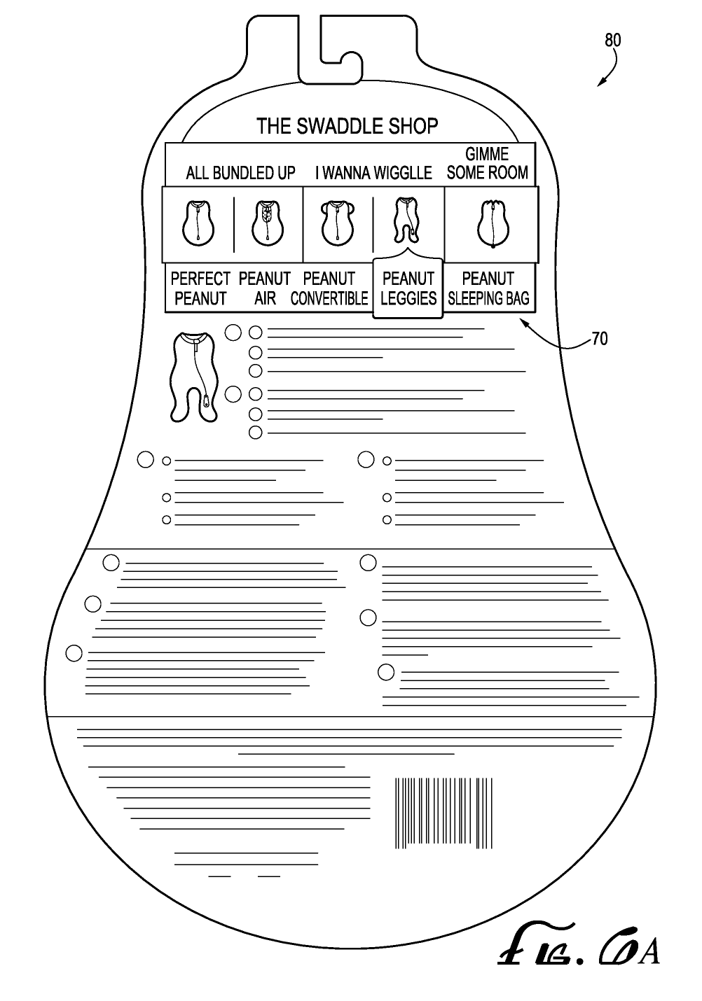

FIG. 5 shows another explanatory display 110 for use in connection with an example embodiment of a system and method of shopping for and marketing of swaddle products for infants and young children. A matrix or selection of different colors and/or graphics 120, 130, 140 are provided as indicia to identify different categories, subcategories and/or product characteristics or options to potential purchasers. Selected indicia corresponding to a particular product are displayed or otherwise utilized in association with the product, on product-specific categorization display indicia.

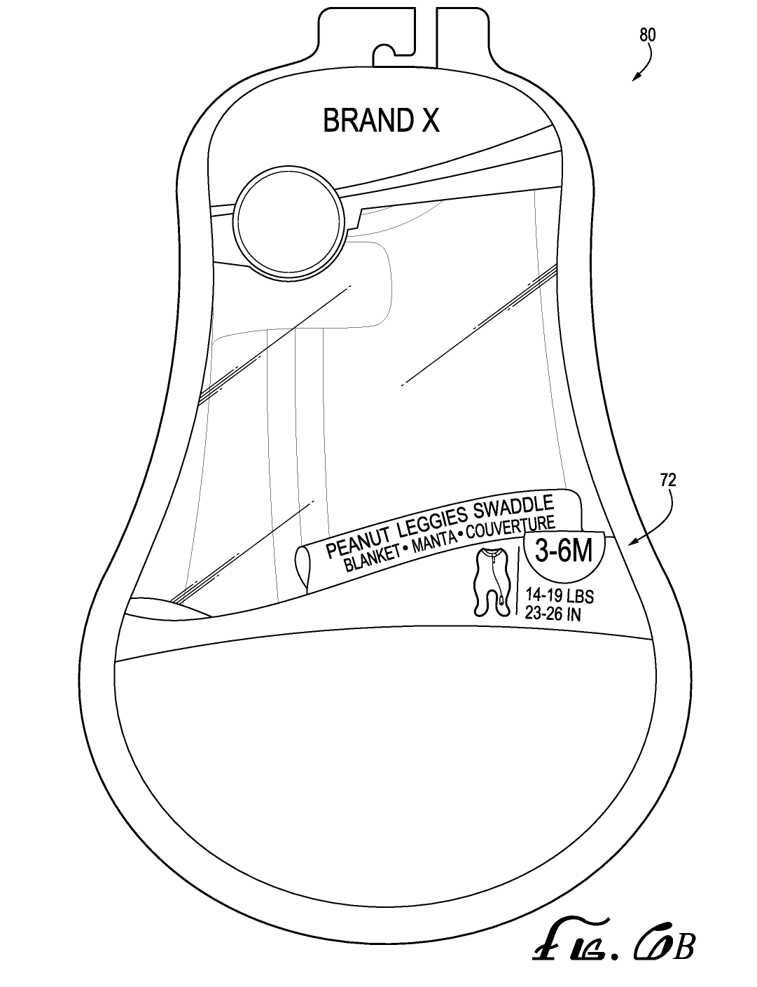

FIG. 6 shows an example embodiment of product-specific categorization display indicia 70, 72 associated with a particular product 80 according to an example form of the system and method of the present invention. FIG. 6A shows a rear labeling portion of the packaged product 80, including all or a portion of the overall explanatory display with at least one product-specific categorization element 70 associated with the particular product 80 being emphasized, for example with an arrow or pointer, bold type, brighter color, larger icon image, or the like. In this manner, a shopper can identify one or more particular features or characteristics (i.e., a product-specific categorization) of this particular product 80, in relation to an overall group of products or market segment. For example in the depicted embodiment, the particular product 80 is a child's swaddle product designated within a “Peanut Leggies™” product-specific categorization, within an overall swaddle product market. FIG. 6B shows a front labeling portion of the packaged product 80, including at least one product-specific categorization element 72 associated with the particular product 80, such as for example a graphic icon, color, pattern, text descriptor or the like, identifying one or more features or characteristics (e.g., style, size, shape, or other market segmentation) of the particular product 80.

In further aspects, the invention relates to shopping guide systems and methods for assisting a shopper or other individual in selecting or identifying one or more particular target products based on one or more product features, characteristics, solutions or benefits, from an overall group of products or market segment. Example embodiments comprise a “drill-down” structure, wherein a shopper selects a first product-specific categorization from a plurality of available first-level product-specific categorizations. Optionally, the system and method further comprises additional levels of selection, for example allowing the shopper to further narrow their choices by selection of a second product-specific categorization from a plurality of available second-level product-specific categorizations; and optionally further selection of a third product-specific categorization from a plurality of available third-level product-specific categorizations; and so on.

In example forms, the system and method relate to shopping guide systems and methods for assisting in the selection of a swaddle or sleep garment system for a child. For example, a shopper first selects a desired first-level product-specific categorization such as a general sleep style associated with particular swaddle products, such as for example: stationary sleep style, active or moving sleep style, or loose and roomy or alternative product style. A graphic icon, color, pattern, text descriptor or some product-specific categorization element associated with the sleep style of each particular product is preferably provided on the product or its packaging, labeling or marketing materials. The shopper optionally further narrows their swaddle selection by selection from one or more additional levels of product-specific categorization, such as for example product shape (e.g., closed swaddle, arms-free, legs-free, tapered, reverse-tapered, or sleeping bag); functionality (e.g., snug-fit, loose fit, car seat-compatible, or transitional multi-use swaddle products); warmth (e.g., cold or warm weather, all-season, hot or cold sleeping individual), gender (e.g., boy, girl, or gender-neutral); fashion type or level (e.g., dress-up or play); product sizing (e.g., extra-small, small, medium, large, extra-large), etc. One or more easily identifiable graphic icons, colors, patterns, text descriptors or other product-specific categorization elements associated with each level of product-specific categorization is preferably provided on the product or its packaging, labeling or marketing materials.

While the invention has been described with reference to preferred and example embodiments, it will be understood by those skilled in the art that a variety of modifications, additions and deletions are within the scope of the invention, as defined by the following claims.

What is claimed is:

1. A method for improved efficiency in the marketing and purchase of products within a marketplace, the method comprising:
defining at least one category of information associated with a group of products;
identifying at least one product-specific categorization within each category of information;
associating at least one product-specific categorization with a particular product selected from the group of products; and
communicating the product-specific categorization associated with the particular product to a potential customer.

2. The method of claim 1, further comprising providing an explanatory display differentiating the product-specific categorizations within each of the categories of information.

3. The method of claim 1, wherein the step of communicating the product-specific categorization associated with the particular product to a potential customer comprises applying to the particular product at least one product-specific categorization display indicia.

4. The method of claim 3, wherein the product-specific categorization display indicia comprises indicia selected from color, text, graphics or combinations thereof.

5. The method of claim 1, wherein the at least one category of information associated with a group of products comprises at least one of style/platform type, function/benefit, and sizing.

6. The method of claim 1, wherein the at least one category of information associated with a group of products comprise style/platform type, function/benefit, and sizing.

7. The method of claim 1, wherein the group of products comprises a plurality of swaddle products for babies.

8. A system for improved efficiency in the marketing and purchase of products within a marketplace, the system comprising:
a group of products, each particular product within the group of products comprising at least one product-specific categorization characteristic corresponding to an associated category of information relevant to the group of products; and
at least one product-specific categorization display indicia associated with each particular product.

9. The system of claim 8, wherein the at least one product-specific categorization display indicia is applied to product packaging for the particular product associated therewith.

10. The system of claim 8, wherein the at least one product-specific categorization display indicia is applied to a point-of-purchase display associated with the particular product.

11. The system of claim 8, wherein the at least one product-specific categorization display indicia is applied to labeling applied to the particular product.

12. The system of claim 8, wherein the at least one product-specific categorization display indicia is applied to digital media associated with the particular product.

13. The system of claim 8, wherein the product-specific categorization display indicia comprises indicia selected from color, text, graphics or combinations thereof.

14. The system of claim 8, further comprising an explanatory display differentiating the product-specific categorization characteristics within each of the associated categories of information relevant to the group of products.

15. The system of claim 8, wherein the at least one product-specific categorization characteristic corresponds to at least one of style/platform type, function/benefit, and sizing.

16. The system of claim 8, wherein the at least one product-specific categorization characteristic comprises a plurality of product-specific categorization characteristics corresponding to style/platform type, function/benefit, and sizing.

17. The system of claim 8, wherein the group of products comprises a plurality of swaddle products for babies.

18. A product selected from a group of products, the group of products collectively having a plurality of associated characteristics within at least one category, and wherein the product selected from the group of products comprises at least one of the plurality of associated characteristics in each category, and further comprising at least one product-specific categorization display indicia associated with the product selected from the group of products.

19. The product of claim 18, wherein the at least one product-specific categorization display indicia is applied to product packaging for the product selected from the group of products.

20. The product of claim 18, wherein the at least one product-specific categorization display indicia is applied to a point-of-purchase display associated with the product selected from the group of products.

21. The product of claim 18, wherein the at least one product-specific categorization display indicia is applied to labeling applied to the product selected from the group of products.

22. The product of claim 18, wherein the at least one product-specific categorization display indicia is applied to digital media associated with the product selected from the group of products.

23. The product of claim 18, wherein the plurality of associated characteristics within at least one category corresponds to at least one of style/platform type, function/benefit, and sizing.

24. The product of claim 18, wherein the plurality of associated characteristics within at least one category correspond to style/platform type, function/benefit, and sizing.

25. The product of claim 18, wherein the product-specific categorization display indicia comprises indicia selected from color, text, graphics or combinations thereof.

26. The product of claim 18, comprising a swaddle product for babies.

27. A product-specific categorization display indicia for use in association with a product selected from a group of products, the group of products collectively having a plurality of associated characteristics within at least one category, and wherein the product selected from the group of products comprises at least one of the plurality of associated characteristics in each category, wherein the product-specific categorization display indicia corresponds to the at least one of the plurality of associated characteristics of the product selected from the group of products.

28. The product-specific categorization display indicia of claim 27, being applied to product packaging for the product selected from the group of products.

29. The product-specific categorization display indicia of claim 27, being applied to a point-of-purchase display associated with the product selected from the group of products.

30. The product-specific categorization display indicia of claim 27, being applied to labeling applied to the product selected from the group of products.

31. The product-specific categorization display indicia of claim 27, being applied to digital media associated with the product selected from the group of products.

32. The product-specific categorization display indicia of claim 27, wherein the plurality of associated characteristics within at least one category corresponds to at least one of style/platform type, function/benefit, and sizing.

33. The product-specific categorization display indicia of claim 27, wherein the plurality of associated characteristics within at least one category correspond to style/platform type, function/benefit, and sizing.

34. The product-specific categorization display indicia of claim 27, comprising indicia selected from color, text, graphics or combinations thereof.

35. The product-specific categorization display indicia of claim 27, comprising information associated with a swaddle product for babies.
